(19) United States
(12) Patent Application Publication
(10) Pub. No.: US 2017/0116388 A1
(43) Pub. Date: Apr. 27, 2017

(54) Lifestyle and phenotype database and analytics platform

(71) Applicant: Greg Robinson, Colchester, VT (US)

(72) Inventor: Greg Robinson, Colchester, VT (US)

(21) Appl. No.: 15/330,076

(22) Filed: Oct. 26, 2015

(51) Int. Cl. G06F 19/00; G06F 17/27

(52) U.S. Cl. CPC G06F 19/3431; G06F 19/322; G06F 17/2785; G06F 17/2705; G06F 17/2755; G06F 17/277

(57) ABSTRACT

Presently, there are no inventions that combine the ability for a user to enter data into an electronic system using unstructured text, with natural language processing (NLP) used to parse, morph, and lexically match the user's input to existing medical classifications of the user's input, and distill the NLP data into keywords for use in binary and logarithmic frequency count and distribution statistical analysis. The inventor has understood the gap in this technology in an industry in which data are required to improve the health of people under, or at risk for, disease distress. This new technology enables automatic and manual data capture by the user, integrates the gathered unstructured data, distills it to discrete data and uses such in relational form to perform statistical analysis on disease likelihood risk factors.

### CROSS REFERENCE TO RELATED APPLICATIONS

This application for non-provisional patent claims priority to and benefit of provisional patent application 62/196,815 titled, “Lifestyle analytics database platform, and app system”. The cross-referenced provisional patent application No. 62/196,815 was filed on Aug. 7, 2015 date pursuant to 35 U.S.C. §111(a)-(b). This application is related to U.S. Patent Publication Number U.S. Pat. No. 6,915,254 B1, titled “Automatically assigning medical codes using natural language processing” published Jun. 5, 2005. This application is related to PCT Patent Application No, PCT/US2013/055591, titled “Systems and methods for processing patient information”, filed on Aug. 19, 2013 that is herein incorporated by reference. This application also is related to U.S. Patent Application Number U.S. Ser. No. 12/498,898 titled, “Methods and system for extracting phenotypic information from the literature via natural language processing” published Jan. 14, 2010. This present non-provisional application claims benefit of such previous filing pursuant to 35 U.S.C. §119(e).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Presently in the health data/analytics market there is a lack of inclusion of data related to a person's day-to-day activities that serve to descriptively and deterministically model the determinants of an individual's heath. The phenotype data that is described by a person's daily activities, environment, and reaction to both is a gap in data that is key to full development of knowledge and learning relative to the question of how to improve the health of an individual and population. Having day to day, real life, easily obtained, personal data will allow for a deeper dive into areas traditionally only analyzed using claims or clinical data such as: the impact of research protocols, impact of health and wellness programs, identification of population specific hot spots based on personal and environmental factors and impact of public health programs to only name a few. Population analytics and personal health applications include at best claims based (insurer data) with clinical data captured in an individual medical record to create a picture and at times a prediction of health status. The use of these data are limited as the impact of an individual's daily activities and experiences are not captured excluding data that would inform approximately 70% of the factors that ultimately impact an individual's health. The individual therefore cannot be informed relative to how to stay or get healthy and researches, employers and payers lack true population data to look at the impact of trends in an area etc. The story of “big-data” to date has a large gap limiting the ability to truly identify ways to improve health and reduce costs. The invention set forth herein fills this gap through individual input of data that will be linked with new and innovative analytics. The background analysis of information will be made into useful and informative actionable feedback outlets for individuals, researchers, and employers among others working in the area of health reform.

Presently, there are no inventions that combine the ability for a user to enter data into an electronic system using unstructured text, with natural language processing (NLP) used to parse, morph, and lexically match the user's input to existing medical classifications of the user's input, and distill the NLP data into keywords for use in binary and logarithmic frequency count and distribution statistical analysis.

The inventor has understood the gap in this technology in an industry in which data are required to improve the health of people under, or at risk for, disease distress. In the field presently, surveys based on a priori hypotheses are constructed and the data electronically captured in systems such as Excel or SurveyMonkey. These systems fall short of use of NLP as in invention filed under patent U.S. Pat. No. 6,915,254 B1 (Automatically assigning medical codes using natural language processing) to automatically derive the classification of medical symptoms as entered in free text by a user. In the aforementioned invention, the classification of the symptoms using NLP is performed to match to billing codes. This invention deviates from that work by using the NLP derived medical classification to assign a symptom, and the use of those symptoms used to feed the statistical analysis of those symptoms in regression or other statistical model to understand the meaning of the symptom(s) in relation to the other variables in the statistical model and push notification of this meaning to the user(s).

### BRIEF SUMMARY OF THE INVENTION

This invention comprises an integrated desktop application, smartphone application, and database platform that gathers data related to a user's phenotype and uses natural language processing combined with statistical analysis to create a profile of both individual and population health behavior according to demographic and environmental dimensions. Data from a user's smartphone or tablet that are entered by the user and collected at the application programming interface level from the device itself, having synchronous or asynchronous Internet connectivity and location technology, are conjoined with externally derived environmental databases as well as potential other data sources, including but not limited to, clinical data, insurance payer claims, researcher databases, to provide population health profiles and statistics, both descriptive, prospective, and predictive. The background analytics result in several novel results including: (1) providing notifications to users called AHA! Moments™ to their smartphone, tablet or other devise, comprising learning moments, health related resources and other health and individual connections such as a research relationship or interaction with similar individuals; (2) providing feedback and connection points to researchers advancing projects requiring and benefiting from cohort specific lifestyle phenotype analytics used to identify previously unknown variables, gaps in research or other data points to improve analysis; and, (3) a broad use of population health data points feeding the work and analysis of employers, municipalities, health care providers and other related populations looking to improve and fill analytics space where phenotypic analytics have not been readily available.

Transformation of data through natural language processing and statistical analytics techniques are applied to the raw, unstructured data that are entered in by users of the platform within their application of choice (personal computer, smartphone, or tablet), to provide population level information associated with manually or automatically generated cohorts of users. Additionally, analytics related to user cohorts and associated AHA! Moments™ are delivered through the platform to either researcher or care team or general client user types through the platform's notifications and messaging capabilities. The totality of the aggregated data is culminated within a Holy Grail Data Base (HGDB), which is amalgamation of environmental, lifestyle, clinical, and claims data, made commercially available to clients for population level health analytics, and informed consent enabled person level analytics.

### BRIEF DESCRIPTION OF THE SEVERAL VIEWS OF THE DRAWING

The invention will be more fully understood and further advantages will become apparent when reference is had to the following detailed description of the preferred embodiments of the invention and the accompanying drawings, in which:

FIG. 1 illustrates a flow chart schematic of the lifestyle data gathering, processing, and integrated analytics application system of the subject invention;

FIG. 2a illustrates an example screenshot on a Smartphone display of the User Interface after executing the app;

FIG. 2b illustrates a Smartphone with the user's AHA! Journal app on the display;

FIG. 3a illustrates an example display screen wherein the user manually opens the app and receives an AHA! Moments notification;

FIG. 3b illustrates the example display screen wherein the user manually opened the app and receives an AHA! Moment with integration to interact with new user types associated with the event;

FIG. 4 illustrates the Community application and integration to the AHA! Platform;

FIG. 5 illustrates an example of patient engagement techniques inherent to the platform; and

FIG. 6 illustrates how the app's local data is kept updated with the most relevant and current data and how process mates to product use, as shown in a flow chart.

### DETAILED DESCRIPTION OF THE INVENTION

The present invention provides a free standing application for a mobile device and/or desktop computer and/or tablet device that is capable of producing for users' notifications, gamification events, and analytics related to the processing of data that are gathered and integrated from user-generated input, smartphone native application programming interface data, and external third party data. User generated data are received by the application's user interface, are processed by server-side application logic modules, and stored in both raw and post-processed format within the application's database, where they are integrated with said other data. The application provides phenotype analytics and gamification to its users, in addition to recaps of the user's phenotype along the dimensions of environment, lifestyle activities, food consumed, sentiment, and physical symptoms. The recaps are provided on the basis of the user's self-reported data-entry, as well as data derived from application programming interface to third party databases and the smartphone device native application programming interface.

The established method for gathering these phenotypic data are disparate and a blend of digital and analog methods. The analog process involve the capturing on paper, in a physical journal or notebook, the daily logs of activities, meals, physical symptoms, or related data. The processes of these data have been limited to transcribing the paper-written notes into a spreadsheet or database, and manual review of the data in it's entirety or in snippets performed by a reviewer. This invention combines new processing technology: web-based or smartphone based application electronic forms that pass the data directly to a centralized database, located on a distributed database platform; natural language processing to derive the appropriate and relevant text from the data entered by the user to enable the capturing of only keywords that will have clinical and/or statistical relevance for purposes of clinical and research analytics; the electronic processing of advanced statistics in the form of multiple machine-based learning techniques such that the computer derives the statistical association of keywords in both supervised and unsupervised formats such that combinations of independent and dependent variables that hold statistical relevance are brought to prominence for both a priori and non-a priori models. It has long been established that conjoining environmental data, such as temperature at a particular point in time in space, with other data can be accomplished through normal relational database management system means. This invention, however, brings a newness to that form of analysis by creating a standardized interface using an application programming interface to existing environmental databases, that routes those data for use in analytics to lifestyle analytics as captured and processed by natural language processing, according to a particular time in space, and further links the data in a single, centralized repository, to clinical and insurance claims data, and genomics data in a manner that enables analytics to be performed on a single longitudinal record across a population or sub-population cohort.

The patent filed as U.S. Patent Application Number U.S. Ser. No. 12/498,898 titled, “Methods and system for extracting phenotypic information from the literature via natural language processing” published Jan. 14, 2010, is closest in methods and means to this invention, however that work is based on information retrieval from extant literature. This invention employs an electronic system, the AHA! platform, to collect the data that are processed using NLP techniques and further takes the step of deriving the statistical analytics that used for the creation of AHA! Moments, the analytic notifications of statistically analyzed data related to user's and population's health for purposes of research, patient engagement, and clinician information at both the patient and population levels.

The lifestyle analytics application/mobile application displays messages targeted to a user's cohort dimensions; cohorts are either manually generated by a user or automatically created based on user input concerning their self and background. The messages sent to the user are either human or machine learned then analyzed data related to integrated data from the platform's Journal Entry module, as either standalone or conjoined with external third party data that includes but is not limited to: insurance claims, electronic health records, genomics databases, environmental databases. When a user generates new data in the form of a journal entry or forum entry from either the Journal Entry module or the Community application's Journal or Forum module, those data are passed, along with information native to the Smartphone's application programming interface, such as GPS location data and native health API data, or the desktop computer's IP address location derived data, to the lifestyle analytics platform database. Those data are analyzed an integrative fashion and in congruence with the data-entry user's preferences to other data gathered on the user's behalf, such their insurer's claims data or provider's held medical record data. Natural language processing is performed on the raw user-generated data to derive common keywords, health-related triggers or symptom data, and general keywords of significance related to the user's associated cohort(s). Statistical analysis is performed on the data that has been natural language processed, to derive models of significance that are then stored within the lifestyle analytics platform transactional database for presentation back to the user and associated user-types in the form of notification and messages within the user interface of the platform.

The lifestyle analytics platform is appointed for use with a smartphone device or desktop computer having location providing technology, such as GPS, a display screen and Internet connectivity, and wherein the display screen displays a plurality of modules provided by the platform.

The Smartphone Journal application runs efficiently on the device without being dependent on continuous Internet connectivity. When the application is running, either in the background or the foreground, synchronous communication with the platform's web server will activate push-style messages related to new notifications of interest to the user. Such notifications may be either the AHA! Moments, that describe new health determinants or behaviors of interest, or new matches to resources of interest related to their health status, condition, or lifestyle behaviors. When at least one match or correlation is determined, the lifestyle analytics platform notifies the user of the opportunity to connect with the matched resource (a cohort user, health care researcher, treatment provider, or group). The application notifies the user of the match by displaying at least one message on the display of the device. Alternatively, the device may also generate an audible sound or vibration (as selected by the user) to alert the user that a message has been generated by the platform, displaying the notification or message.

Generally, the application logic for the present invention requires five separate processing logics:

1. Tokenization and parsing of the data entry from the Journal app journal module entry or Community Private Journal or Forums that are entered by users in unstructured free text
2. Temporal linking of relations that hold between events, times or between an event entered by the user as a row to the database and a time in space
3. Topic matching of all keyword data using latent dirichlet allocation*
4. Lexical matching of physical symptoms as reported by the user to medical classification of symptoms database
5. Original value of physical symptoms as reported by the user, and pre-Lexical matching storage as keywords to the database
6. Value-based matching of activities keywords to map activities entered by the user to a typology level of aerobic activity, as defined by mathematical algorithm that calculates the overall aerobic activity score; reporting of the overall aerobic activity score is written separately to the database, in addition to the individually derived activities as keywords
7. Gathering of identified key words, temporal links, and/or topics to effectuate counts as binary and logistic frequencies of keywords relative to points in time in space
8. Statistical analyses of staged data to identify health determinants or dimensions as mined from user-generated data, that have statistical relevance

a. A priori analyses on data by cohort dimensions
i. Regression of key words with or without temporal links and/or topics to find correlation to the log of the cohort dimensions counts
ii. Other predefined multivariate regression models on natural language processed key words, topics, temporal links against user demographic, environmental, claims, clinical, or genetic data

b. Affinity association, neural net and related machine learning programming of natural language processed key words, and environmental variables derived from third party databases, such as weather temperature or humidity, as independent variables, are analyzed against demographic, cohort population-level dimensions, claims, clinical, or genetic data as the dependent variables.

*Step 3 in the process above is deployed as an optional processing logic for satisfying of demand for more robust models in certain disease cohorts.

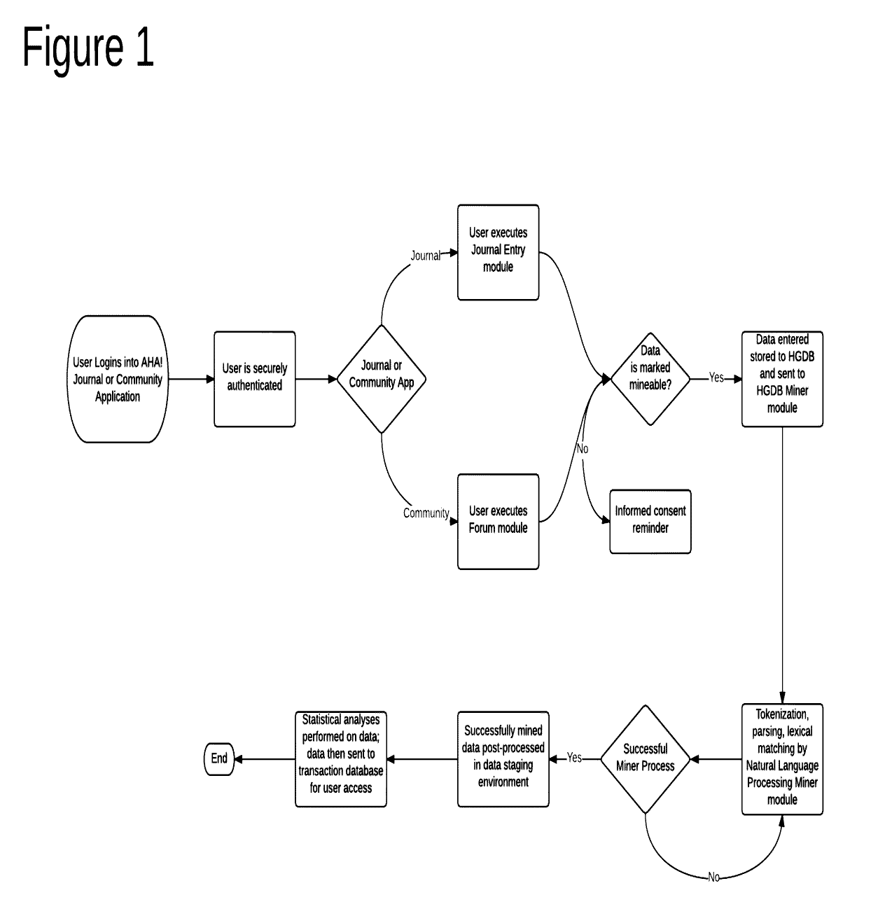

FIG. 1 shows the general workflow of the platform. A user logs into the secure platform (mobile device or computer/tablet platform), in either the Journal app or the Community app. Once authenticated, the user will access a data entry screen, depending upon which application the user has authenticated into. In the Journal app, it will be the Journal entry module. In the Community app, this either their personal Journal entry screen or the Forum the user is enrolled into that contains a cohort of users with characteristics of similarity to the user, based on demographic and/or clinical dimensions.

If the data the user enters is marked as private, the data are passed into the Holy Grail Database (HGDB) for transaction level storage and app logic processing (as defined by Steps 1-8 above). The data are then picked up and used by the HGDB Miner module, where natural language processing is applied, as described by the first six of eight processing logic steps outlined above. Statistical analysis of the results of the natural language processed data then occurs in the final 2 post-processing steps, as described in steps seven and eight of the processing logic steps outlined above.

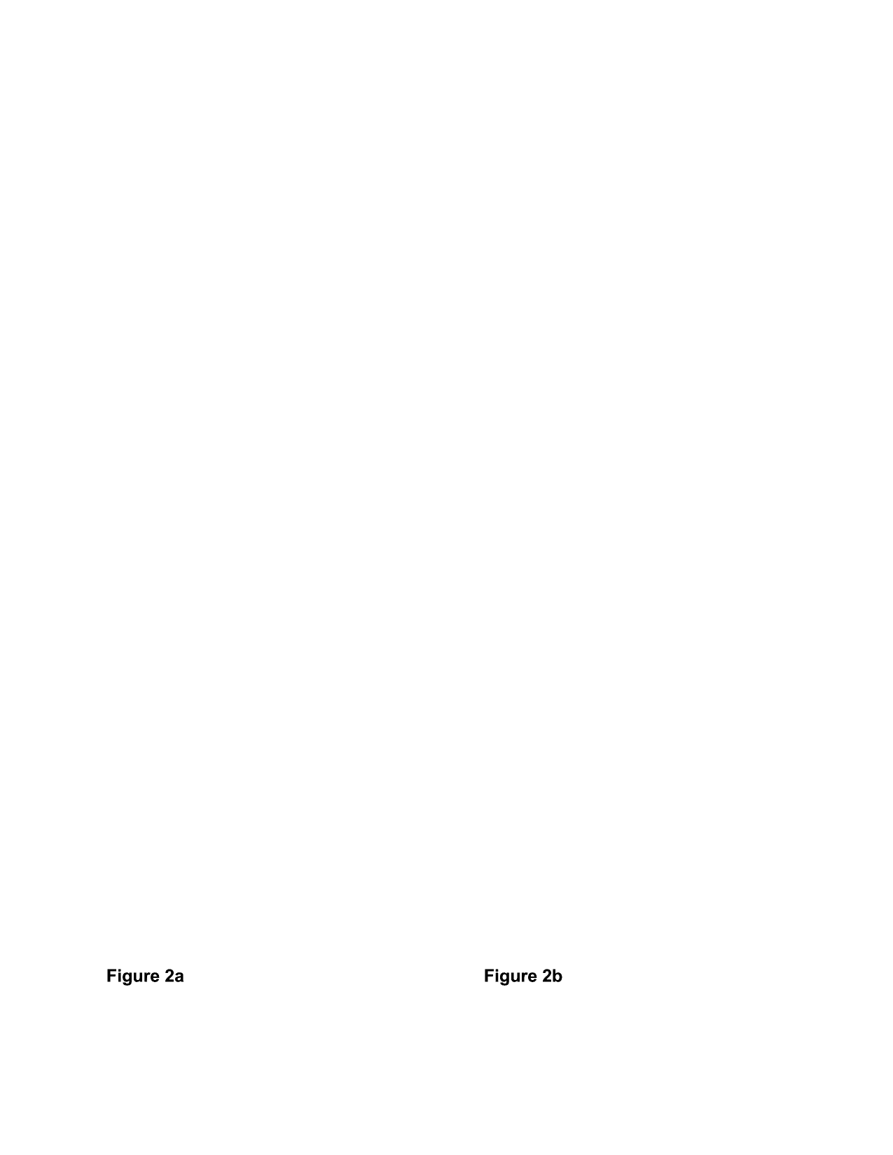

FIG. 2 shows the Journal app user interface and progression within the application from the user being logging in and successfully authenticated on the mobile device, through selection of the Journal module. FIG. 2b shows the user interface for the Journal module, in which a user has received a new AHA! Moment (data derived from the natural language and statistical analytic app logic processes).

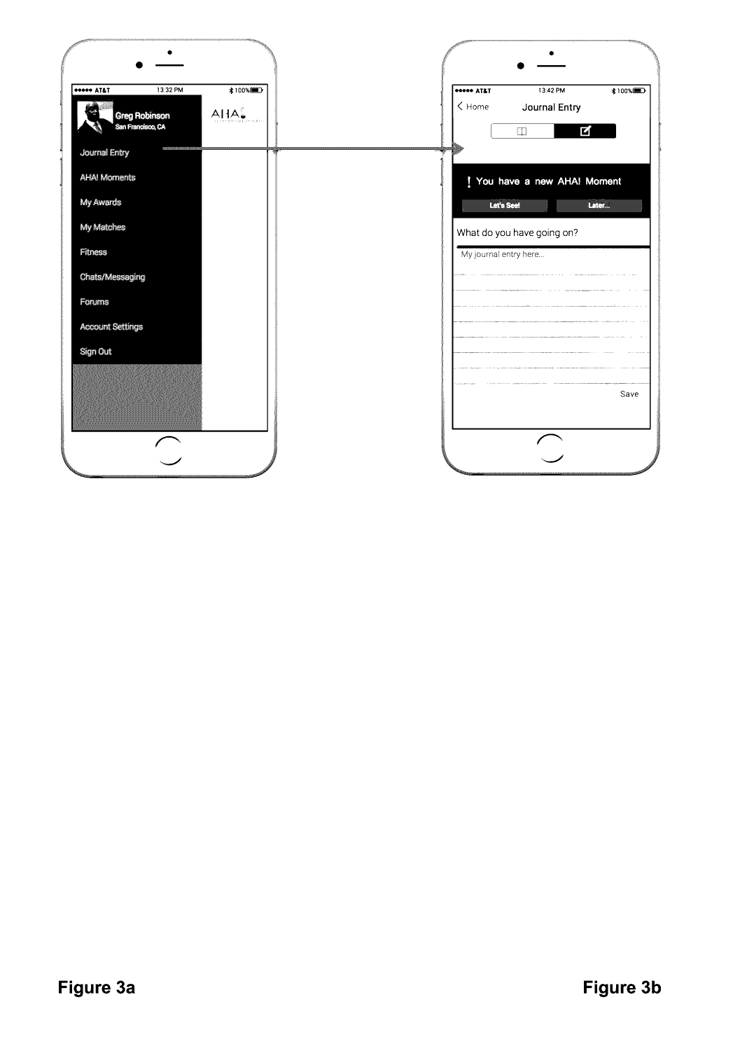

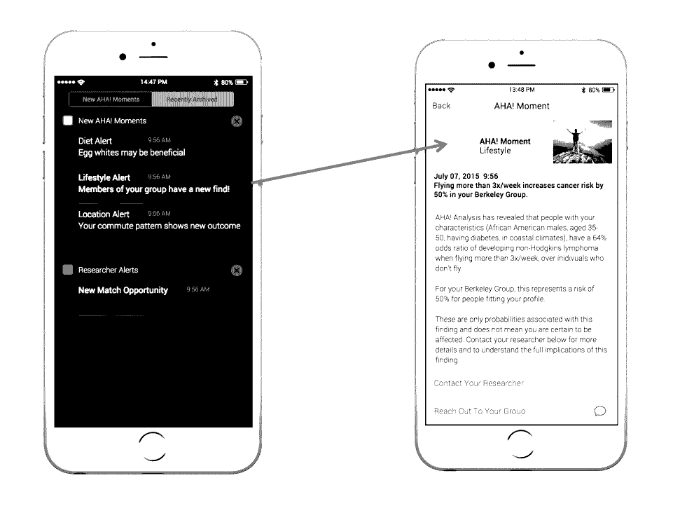

FIG. 3 shows the authenticated user within the Journal app receiving a full menu of AHA! Moments and Researcher Request notifications. The user selects an available Lifestyle type of AHA! Moment in FIG. 3a, and FIG. 3b shows the actual selected Lifestyle AHA! Moment. The user is able to interact with a researcher associated with this AHA! Moment, as well as with cohort of users also affected by this AHA! Moment with whom a relationship within the application has been defined to the user.

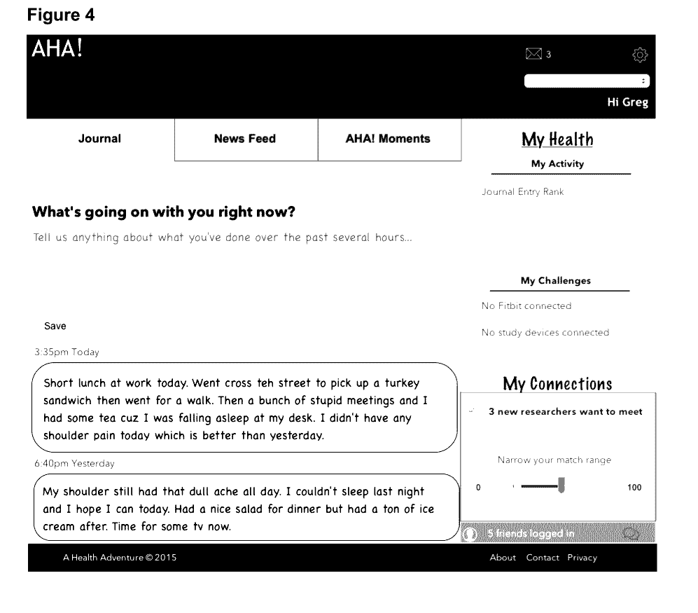

FIG. 4 shows an authenticated user on the primary screen within the Community desktop-optimized app. The user is able to enter a new Journal entry, from the shown Journal tab. The user's My Health module is also exposed, such that user is able to see the gamification aspect of the app, and interact with their progress and/or groups they are involved with around their health challenges, their integrated health based devices. They are also able to interact with their progress on other gamification aspects of the program, namely their progress to awards and incentives related to their goals for number of Journal entries. FIG. 4 shows the interactivity with health researchers that are matched to aspects of their profile, with the ability to narrow or expand the reach of the algorithm in matching their profile to available researchers to interact with around aspects of health germane to their profile. The user is also able to interact with chat, messaging, news feeds, and AHA! Moments (post-processed natural language programmed and statistically analyzed data relevant to their profile, as a function of their demographic, lifestyle, clinical, claims, genomic, and/or environmental data). Chat, messaging, and news feed are all tied to the user's profile to provide connectivity to other users, groups, or content that are related to their profile.

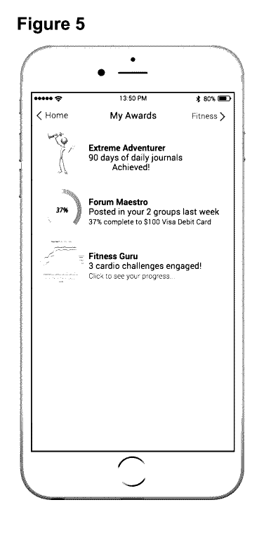

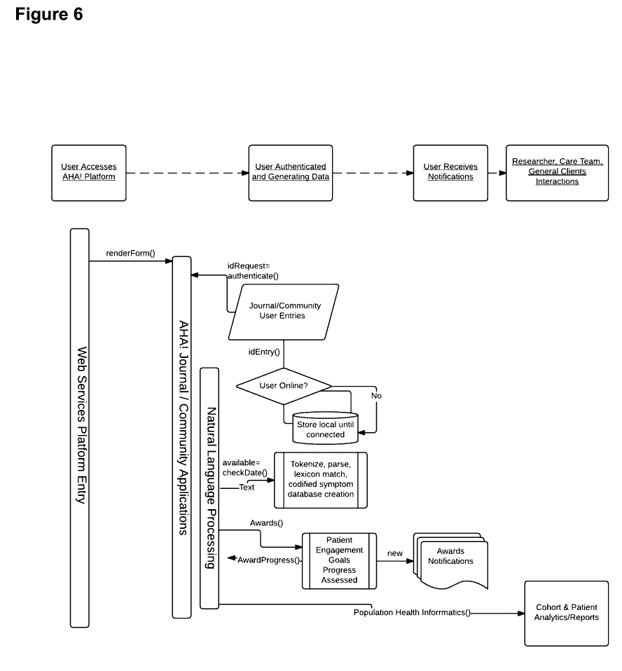

FIG. 5 shows gamification of the platform, whereby the user is presented with a progress screen of where they stand with the receipt or historical achievement of awards related to the interactivity with the platform.

FIG. 6 is a workflow of the application interface along the vertical swim lane outline, and the application processing logic shown below the application interface heading. The user is authenticated to the platform into either the Community or Journal application. Once authenticated, the generating of data occurs by the user, and application level logic occurs at the natural language processing level against the Journal/Community user entries. If the user is not on the Internet when generating the data, data is stored to the device's local storage for asynchronous processing. Synchronous processing occurs when the user's device is next on the Internet. Natural language processing continues against the user entered data in the form of tokenization, parsing, lexicon matching, topic matching, temporal linking, database codification and storage of new keywords back to the transaction level database. Recaps of the data are provided for the users in the platform through counts of the keyword data that are available right after the natural language processing stage. Awards for the gamification modules are also processed in this level of data processing, as the processed data then signal application logic counters to advance for the number of and/or type user entries. Additional application logic at this layer occurs for researcher or device based (e.g., Fitbit) engaged awards or challenges. Notifications of awards and/or progress are made to the user and the user interface presents said awards to the user. Analytics in the form of reports on the post-processed data and award achievements are then generated and made available to various user types logged into the platform.

What is claimed is:

1. An integrated application and database platform that gathers data related to a data-entry type of user's lifestyle behaviors being the amalgamation of what physical activities they partake in, what foods they consume, what products they use, their surrounding physical environment (such as weather), and the observable physical symptoms they feel, in conjunction with or asynchronous to their sentiment or emotion (e.g., phenotype data) and uses natural language processing combined with statistical analysis to create a profile of population health behavior according to demographic and environmental dimensions, and wherein said integrated platform includes a plurality of applications comprising:
a. a set of a smartphone and desktop applications with shared application logic and database logics and objects providing entry of user lifestyle data as well as health and location data derived from the smartphone operating system from a user of said device and general client or external third party data;
b. said smartphone and desktop applications operating on devices having Internet connectivity for downloading and displaying at least one notification of statistically relevant data related to said user's manual or automatic system created population cohort(s) as generated from the platform's integrated lifestyle, environment, claims, genomics, and clinical database;
c. said devices being operative to establish an Internet connection between said device and the lifestyle analytics software for downloading data onto said device, said lifestyle analytics platform being operative to retrieve downloaded data from said device, wherein said system executes logic means to gather, natural logic process, statistically analyze, and generate new levels of statistical significance for system learned determinants of health of the compendium of users;
d. said lifestyle analytics applications only displaying said notifications when said notification data is within said statistical relevance to disparate user-types of the system;
e. whereby said notification is triggered when said user enters data and said data are analyzed against aggregate data from other users relevant to said user's demographic or said cohort dimensions.

2. The lifestyle analytics platform as recited by claim 1, wherein said device is a mobile phone or Smartphone.

3. The lifestyle analytics platform as recited by claim 1, wherein said device is a mobile tablet.

4. The lifestyle analytics platform system as recited by claim 1, wherein said device is a computer.

5. The lifestyle analytics platform as recited by claim 1, wherein said message is delivered to said device after a preselected period of time upon entry within said given radial distance.

6. The lifestyle analytics platform as recited by claim 1, wherein no fee is paid by said data-entry type of user of said device.

7. The lifestyle analytics platform as recited by claim 1, wherein a fee is paid by said researcher, care team, or general client type of user of said device for a premium account with said system, wherein said premium account includes advanced functionality associated with said user preferences.

8. The lifestyle analytics platform as recited by claim 1, wherein said Internet connection between said device and said lifestyle analytics application is automatic and said data and analytics are periodically refreshed.

9. The lifestyle analytics platform as recited by claim 1, wherein said data comprises user generated lifestyle data by itself or conjoined with external third party data.

10. The lifestyle analytics platform as recited by claim 1, wherein said data comprises user generated lifestyle data by itself or conjoined with Smartphone generated data as available from the Smartphone native application programming interface.

11. The lifestyle analytics platform as recited by claim 1, wherein said data are processed through natural language processing modules inherent to the lifestyle analytics platform.

12. The lifestyle analytics platform as recited by claim 1, wherein said natural language post-processed data are further processed by statistical analytic processing modules inherent to the lifestyle analytics platform.

13. The lifestyle analytics platform as recited by claim 1, wherein said statistical analytic post-processed data are transformed to human language analyses.

14. The lifestyle analytics platform as recited by claim 1, wherein said human language analyses are provided to various user types using the platform in the form of notifications and messages related to new or enhanced knowledge discovery of health determinants and/or dimensions.

15. The lifestyle analytics platform as recited by claim 1, wherein said enhanced knowledge discovery of health determinants and/or dimensions are further processed as intellectual property owned in whole or part by the lifestyle analytics platform intellectual property owner and disseminated out for public or private use in the advancement of population health.

16. The lifestyle analytics platform as recited by claim 1, wherein said Internet connection between said device and said lifestyle analytics application for downloading data onto said device is provided by way of a data feed execution.

17. The lifestyle analytics platform as recited by claim 16, wherein said data feed execution is set to automatically take place synchronous to Internet connectivity or asynchronously when offline using device native database or storage capabilities.
